(19) United States
(12) Patent Application Publication
(10) Pub. No.: US 2002/0065724 A1
(43) Pub. Date: May 30, 2002

(54) Structure for sales management via network

(75) Inventor: Tamaki Tsuruda, Hyogo (JP)

Correspondence Address: McDERMOTT, WILL & EMERY, 600 13th Street, N.W., Washington, DC, 20005-3096, US

(73) Assignee: MITSUBISHI DENKI KABUSHIKI KAISHA

(21) Appl. No.: 09/854,581

(22) Filed: May 15, 2001

(30) Foreign Application Priority Data
Nov. 27, 2000 (JP) 2000-359348 (P)

(51) Int. Cl. G06F 17/60

(52) U.S. Cl. 705/16

(57) ABSTRACT

A plurality of vending machines are connected via a radio network to a main computer. A common electronic mail address is allocated to these vending machines. A unique identification number ID is allocated to each vending machine. The vending machine transmits electronic mails regularly and at the time of request for replenishment. The main computer manages sales status of each vending machine according to an identification number included in an electronic mail.

### BACKGROUND OF THE INVENTION

1. Field of the Invention

The present invention relates to a structure and a method for sales management. In particular, the invention relates to a structure and a method for managing, via radio, sale by a plurality of vending machines.

2. Description of the Background Art

Vending machines have conventionally been managed by personnel.

The number of goods in stock in a vending machine is accordingly checked by any serviceperson who actually opens the vending machine. Because the machine is unattended, any improper status occurring at a sale of an article cannot immediately be handled.

One approach to save such a labor is disclosed in “Vending Machine” (Japanese Patent Laying-Open No. 2000-149107, hereinafter document 1). Document 1 discloses a network system for managing via the Internet the quantities of commodities sold and in stock respectively.

This network system, however, requires allocation of an IP address and an electronic mail address to each vending machine, resulting in laborious and costly management.

Regarding handling of complaints, a sound collecting microphone could be attached to a vending machine. Even if complaints of consumers can be acknowledged by the sound collecting microphone, handling of the complaints requires any person to be dispatched to the location of the vending machine, therefore, a prompt action is impossible.

### SUMMARY OF THE INVENTION

One object of the present invention is to provide a structure and a method for sales management to enable a low-cost, prompt and easy sales management of vending machines.

According to one aspect of the invention, a sales management system includes a plurality of vending machines each having a unique identification number, a radio network, and a main computer system receiving an electronic mail from each of these vending machines via the radio network. A common electronic mail address is applied to these vending machines. The vending machines each includes a storing unit storing the identification number, a mail producing unit producing the electronic mail including sales status data and the identification number, and a transmitting unit transmitting the electronic mail to the radio network. The main computer system includes a data processing unit classifying sales status of each vending machine according to the identification number included in the electronic mail.

Preferably, the mail producing unit includes a counter counting the number of articles in stock at each sale of an article, a regular handling unit regularly comparing the number of articles in stock with a stock alarm quantity to produce a regular report mail, and a replenish request handling unit comparing, each time the counter operates, the number of articles in stock with the stock alarm quantity to produce a replenish request mail according to result of the comparison.

Preferably, the electronic mail is the regular report mail or the replenish request mail, the main computer system further includes a receiving unit receiving the electronic mail and a display unit, and the data processing unit graphically displays data included in the received electronic mail on the display unit.

In particular, the main computer system further includes a database for accumulating received sales status data by classifying the data on the basis of the identification number.

In particular, the sales management system further includes a computer of a producer producing articles to be sold by the vending machines, the computer capable of retrieving data in the database.

According to another aspect of the invention, a sales management system includes a plurality of vending machines each having a unique identification number, a radio network, and a main computer system transmitting and receiving an electronic mail to and from these vending machines via the radio network. A common electronic mail address is applied to these vending machines. The vending machines each includes a storing unit storing the identification number, a sales management unit for selling an article, a data input terminal unit for accepting complaint information from a consumer, a complaint handling unit producing a complaint handling request electronic mail including the complaint information and the identification number, and a transmitting unit transmitting and receiving an electronic mail via the radio network. The main computer system includes a transmitting and receiving unit transmitting and receiving the electronic mail and a data processing unit extracting data included in the complaint handling request mail to produce a complaint handling electronic mail including a complaint handling execution command. The complaint handling unit accepts the complaint handling execution command according to an identification number included in the complaint handling electronic mail.

Preferably, the complaint handling unit invites the consumer to input a request to the data input terminal unit when the identification number included in the electronic mail and the identification number stored in the storing unit match. The complaint handling unit controls the sales management unit such that the consumer receives refund of money or replacement of an article according to data on the request input to the data input terminal unit.

According to still another aspect of the invention, a sales management method for managing a plurality of vending machines each having a unique identification number and transmitting and receiving an electronic mail to and from a main computer system via a radio network, includes the steps of producing an electronic mail including sales status data and the identification number by the vending machine, transmitting the electronic mail by the vending machine, receiving the electronic mail by the main computer system, and managing by the main computer system sales status of the vending machine by extracting data included in the received electronic mail.

Preferably, the step of producing the electronic mail includes the steps of regularly comparing the number of articles in stock and a stock alarm quantity to produce a regular report mail, and comparing, each time an article is sold, the number of articles in stock and the stock alarm quantity to produce a replenish request mail according to result of the comparison.

In particular, the step of managing sales status includes the step of graphically displaying the data included in the received electronic mail. The managing step further includes the step of updating a database registering the received sales status data using the identification number as a key.

According to a further aspect of the invention, a sales management method for managing a plurality of vending machines each having a unique identification number and transmitting and receiving an electronic mail to and from a main computer system via a radio network, includes the steps of accepting complaint information from a consumer by the vending machine, transmitting the electronic mail including the complaint information and the identification number by the vending machine, receiving by the main computer system the electronic mail from the vending machine, extracting by the computer system data included in the received electronic mail to produce a complaint handling electronic mail including a complaint handling execution command, transmitting by the main computer system the complaint handling electronic mail to the vending machine, receiving by the vending machine the electronic mail from the main computer system, and accepting by the vending machine the complaint handling execution command according to an identification number included in the complaint handling electronic mail.

Preferably, the step of accepting the complaint handling execution command includes the step of inviting a consumer to input a request when the identification number included in the received electronic mail and an identification number of the vending machine match.

In particular, the step of accepting the complaint handling execution command includes the step of making refund of money or replacement of an article to the consumer according to the input request.

According to a still further aspect of the invention, a main computer system connected via a radio network to a plurality of vending machines each having a unique identification number is provided, a common electronic mail address being applied to these vending machines. The main computer system includes a data processing unit managing sales status of each vending machine by extracting data included in an electronic mail transmitted from the vending machine.

Preferably, the main computer system further includes a receiving unit receiving the electronic mail and a display unit. The data processing unit graphically displays data included in the received electronic mail on the display unit.

Preferably, the main computer system further includes a database for accumulating the received sales status data by classifying the data on the basis of the identification number.

According to a still further aspect of the invention, a main computer system connected via a radio network to a plurality of vending machines each having a unique identification number is provided. A common electronic mail address is applied to these vending machines. The main computer system includes a transmitting and receiving unit transmitting and receiving an electronic mail via the radio network, and a data processing unit producing a complaint handling electronic mail including a complaint handling execution command having the identification number according to a complaint handling request electronic mail including complaint information and an identification number transmitted from the vending machines.

Preferably, the main computer system further includes a database for accumulating the transmitted complaint information by classifying the information on the basis of the identification number.

According to a still further aspect of the invention, a client system including a plurality of vending machines each having a unique identification number and connected to a main computer system via a radio network is provided. A common electronic mail address is applied to these vending machines. The vending machines each include a storing unit storing the identification number, a mail producing unit producing an electronic mail including sales status data and the identification number, and a transmitting unit transmitting the electronic mail to the main computer system via the radio network.

Preferably, the electronic mail includes a regular report mail and a replenish request mail, and the mail producing unit includes a counter counting the number of articles in stock at each sale of an article, a regular handling unit regularly comparing the number of articles in stock with a stock alarm quantity to produce the regular report mail, and a replenish request handling unit comparing the number of articles in stock with the stock alarm quantity, each time the counter operates, to produce the replenish request mail according to result of the comparison.

According to a still further aspect of the invention, a client system including a plurality of vending machines each having a unique identification number and connected to a main computer system via a radio network is provided. A common electronic mail address is applied to these vending machines. The vending machines each include a storing unit storing the identification number, a sales management unit for selling an article, a data input terminal unit for accepting complaint information from a consumer, a complaint handling unit producing a complaint handling request mail including the complaint information and the identification number, and a transmitting unit transmitting and receiving an electronic mail including the complaint handling request mail to and from the main computer system via the radio network.

Preferably, the complaint handling unit invites the consumer, when an identification number included in a complaint handling electronic mail transmitted from the main computer system matches the identification number stored in the storing unit, to select one of handling items presented by the complaint handling electronic mail. In particular, the complaint handling unit controls the sales management unit such that the consumer receives refund of money or replacement of an article according to the selected handling item.

According to a still further aspect of the invention, a sales management method by a main computer system for managing a plurality of vending machines each having a unique identification number and connected to the main computer system via a radio network is provided. A common electronic mail address is applied to these vending machines. The method includes the steps of receiving from each of the vending machines an electronic mail including sales status data and the identification number, and managing sales status of the vending machine by extracting the data included in the received electronic mail.

Preferably, the step of managing sales status includes the step of graphically displaying the data included in the received electronic mail.

Preferably, the step of managing sales status includes the step of updating a database registering the received sales status data using the identification number as a key.

According to a still further aspect of the invention, a sales management method by a main computer system for managing a plurality of vending machines each having a unique identification number and connected to the main computer system via a radio network is provided. A common electronic mail address is applied to these vending machines. The method includes the steps of receiving from the vending machines an electronic mail including complaint information and the identification number, extracting data included in the received electronic mail to produce a complaint handling electronic mail including a complaint handling execution command having the identification number, and transmitting the complaint handling electronic mail to the vending machines.

The structure and the method for sales management according to the present invention apply the same electronic mail address to a plurality of vending machines, and each of these vending machines can be identified by a unique identification number thereof indicated in an electronic mail. In this way, cost and labor of management can be reduced.

A remote management of the vending machines is possible. In particular, an electronic mail can be utilized to judge that an out-of-stock state is approaching and accordingly the stock can be replenished before articles are sold out.

Since vending machines transmit and receive data via radio, locations of the vending machines can readily be changed and no work for installing signal lines is required.

Further, sales status is recorded as a database. Therefore, producers can easily conduct market research by retrieving data from the database. Then, the producers can promptly and accurately adjust inventory as well as production in plants.

In addition, complaint information transmitted from vending machines is analyzed by the main computer, and the computer can then transmit a complaint handling execution command to a corresponding vending machine by an electronic mail. A prompt handling of complaints from consumers is thus possible.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 generally shows a structure of a sales management system 1000 according to a first embodiment.

FIG. 2 is a flowchart illustrating an operation of a counter 16 according to the first embodiment.

FIG. 3 is a block diagram showing one example of the structure of a regular handling unit 18 according to the first embodiment.

FIG. 4 is a flowchart illustrating a regular handling according to the first embodiment.

FIG. 5 is a block diagram showing one example of the structure of a request handling unit 20 according to the first embodiment.

FIG. 6 is a flowchart illustrating a replenish request handling according to the first embodiment.

FIG. 7 generally shows a structure of a sales management system 2000 according to a second embodiment.

FIG. 8 shows a structure of the front face of a vending machine 3B according to the second embodiment.

FIG. 9 is a flowchart showing a procedure of complaint handling according to the second embodiment.

FIG. 10 shows a flow of screens displayed on a data input terminal unit 66.

### DESCRIPTION OF THE PREFERRED EMBODIMENTS

Embodiments of the invention are hereinafter described in conjunction with the drawings. It is noted that like or corresponding components in the drawings are denoted by the same reference character and description thereof is not repeated.

First Embodiment

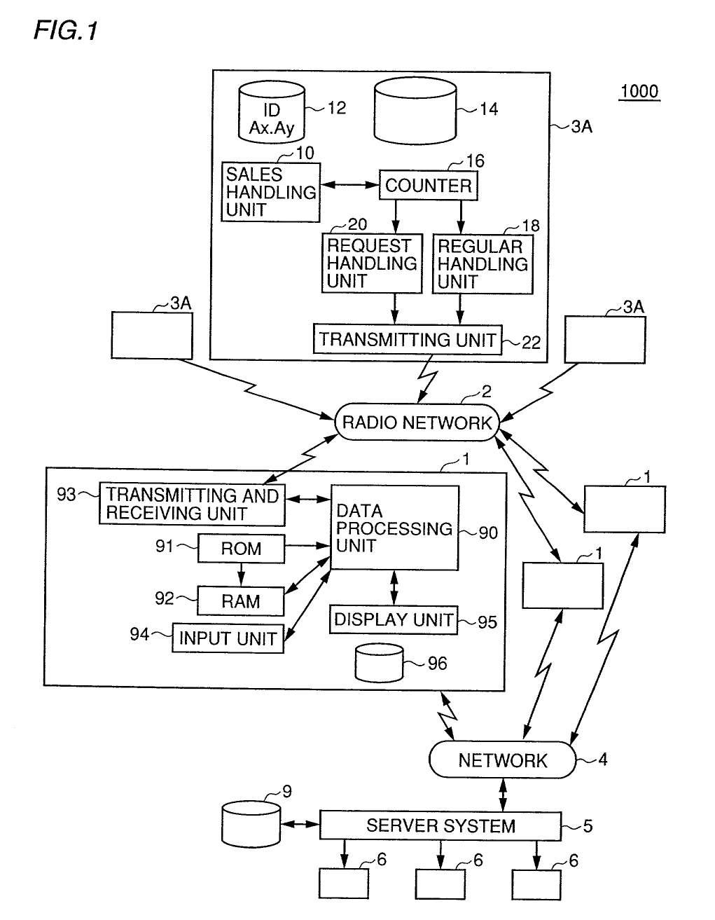

A sales management system 1000 according to a first embodiment is now described. Referring to FIG. 1, a plurality of vending machines 3A are connected via a radio network 2 to a main computer 1 installed in a distribution and counting center, management division, or the like.

A common electronic mail address Ax is allocated to these vending machines 3A. A unique electronic mail address Ay is allocated to each main computer 1.

Vending machines 3A are each provided with a unique identification number ID. Main computer 1 manages the vending machines by using identification number ID as a key.

Vending machines 3A to which the common electronic mail address Ax is allocated are structured to transmit to the common main computer 1 electronic mails at regular and irregular intervals.

Vending machine 3A is detailed below. Vending machine 3A includes a sales handling unit 10 for vending goods according to manipulation by consumers, files 12 and 14, a counter 16 for counting the number of goods in stock, a regular handling unit 18 for executing a regular handling, a request handling unit 20, and a transmitting unit 22 for transmitting electronic mails via radio network 2.

Data stored in file 12 contains unique identification number ID, electronic mail address Ay of main computer 1 to which an electronic mail is addressed, and electronic mail address Ax of the vending machine itself. Data stored in file 14 contains management data for goods and the vending machine (names of goods, number of goods in stock, stock alarm quantity, location of the vending machine and the like).

Counter 16 updates the number of goods in stock according to the number of sold goods handled by sales handling unit 10.

Regular handling unit 18 has a timer therein to execute a regular handling described later at predetermined intervals. Results of the regular handling are transmitted to main computer 1 via transmitting unit 22. Without the internal timer, the regular handling may be performed following a control command regularly issued by main computer 1.

Request handling unit 20 irregularly conducts its handling operation. Results of the handling by request handling unit 20 are sent to main computer 1 via transmitting unit 22. According to the first embodiment, the number of goods in stock is irregularly monitored and main computer 1 is requested to replenish the stock depending on the number of remaining goods (this handling is hereinafter called replenish request handling).

Transmitting unit 22 is structured of a device for radio data transmission, such as portable terminal and PHS (personal handy-phone system), for example. Transmitting unit 22 transmits an electronic mail to electronic mail address Ay stored in file 12. If a mobile phone, PHS or the like is used, data is communicated via a mobile phone company.

Main computer 1 includes a data processing unit 90 formed of a CPU (central processing unit), a ROM (read only memory) 91, a RAM (random access memory) 92, a transmitting and receiving unit 93 for data transmission and reception, an input unit 94 including keys, a mouse and the like, a display unit 95 indicating data, and a file 96. Data processing unit 90 controls processes in RAM 91, ROM 92, transmitting and receiving unit 93, input unit 94, display unit 95 and file 96 as well as data processing for electronic mails received via network 2.

Main computer 1 is connected via a network 4 to a server system 5. Server system 5 summarizes sales status data from a plurality of main computers 1 to accumulate the summarized data in a database 9.

Contents recorded in database 9 can be disclosed to computers 6 of contracted (registered) producers.

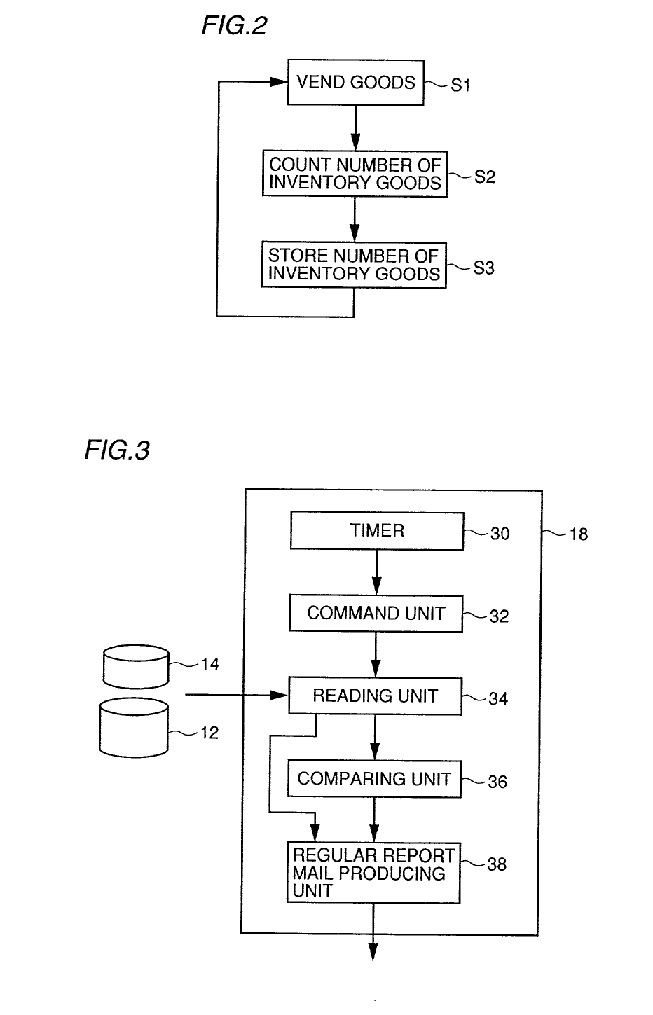

Management of the number of inventory commodities is described now in conjunction with FIG. 2. Each time a commodity (commodities) is (are) sold, data indicative of the number of sold commodities is transferred from sales handling unit 10 (step S1). Counter 16 subtracts the sales number from the number of inventory commodities to calculate a renewed number of inventory commodities (step S2). The new number may be calculated by subtracting the sales number from the inventory number held in counter 16 or by reading the inventory number stored in file 14 from which the sales number is subtracted. The resultant number calculated by counter 16 updates the inventory number in file 14 (step S3).

Description is given below of a structure of regular handling unit 18 in conjunction with FIG. 3. Referring to FIG. 3, regular handling unit 18 includes a timer 30, a command unit 32 according to an output from timer 30 to regularly issue a regular report mail producing command, a reading unit 34 reading data from files 12 and 14, a comparing unit 36 for comparing an inventory alarm quantity with a current number of inventory goods, and a regular report mail producing unit 38 creating a regular report mail to output the mail to transmitting unit 22.

Comparing unit 36 determines the difference between the inventory alarm quantity and the current number of inventory goods. The difference may be calculated by using the inventory number data supplied from counter 16 or by using inventory number data read from file 14.

Transmitting unit 22 shown in FIG. 1 receives the produced regular report mail to transmit the regular report mail to electronic mail address Ay stored in file 12.

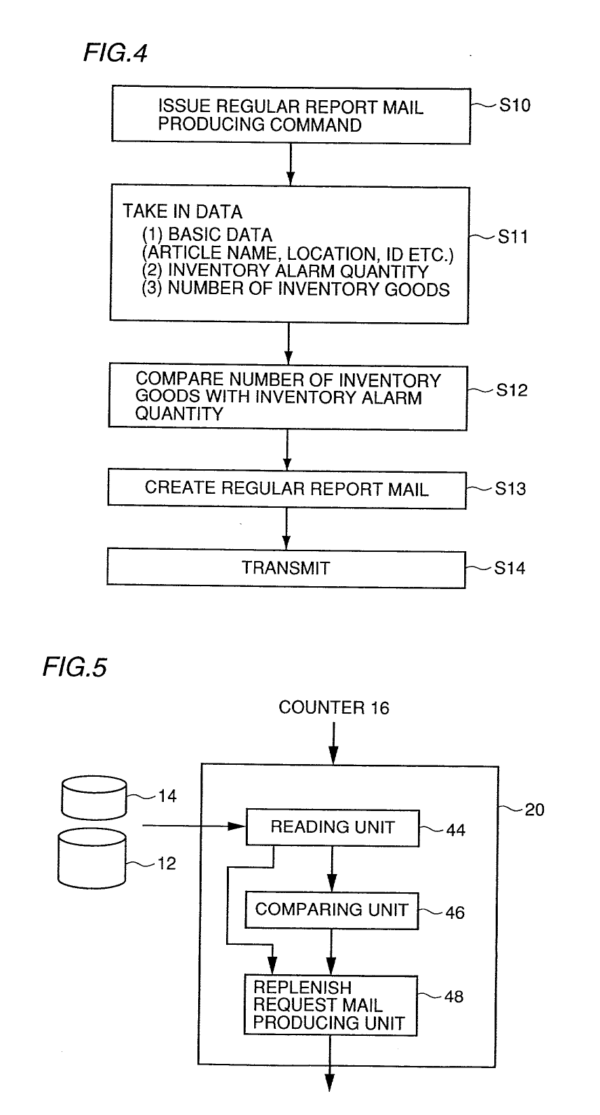

A regular handling according to the first embodiment is described in detail in conjunction with FIG. 4. Referring to FIG. 4, command unit 32 issues a regular report mail producing command according to an output from timer 30 (step S10).

Upon the issue of the regular report mail producing command, regular handling unit 18 takes in (1) basic data (name of goods, location of vending machine, identification number ID and the like), (2) inventory alarm quantity and (3) number of inventory goods (step S11).

Comparing unit 36 compares the inventory alarm quantity with the number of inventory goods (step S12). Regular report mail producing unit 38 generates a regular report mail containing (1) basic data (2) inventory alarm quantity, (3) number of inventory goods and (4) result of comparison (step S13).

The regular report mail is transmitted toward main computer 1 via transmitting unit 22 (step S 14).

A structure of request handling unit 20 is described in conjunction with FIG. 5. Referring to FIG. 5, request handling unit 20 includes a reading unit 44 reading data from files 12 and 14, a comparing unit 46 comparing an inventory alarm quantity with a current number of inventory goods to issue a replenish request mail producing command, and a replenish request mail producing unit 48 creating a replenish request mail to output the mail to transmitting unit 22.

Comparing unit 46 determines the difference between the inventory alarm quantity and the current number of inventory goods. The difference may be calculated by using the inventory figure data output from counter 16 or using the inventory figure data read from file 14.

Transmitting unit 22 shown in FIG. 1 receives the created replenish request mail and transmits this mail to electronic mail address Ay stored in file 12.

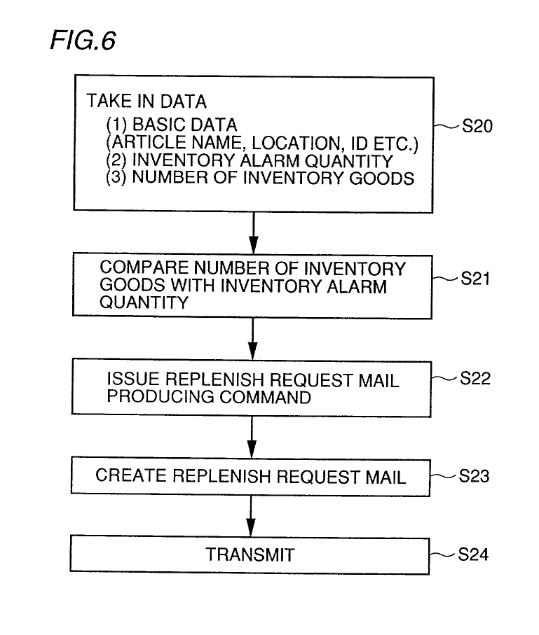

Details of a replenish request handling according to the first embodiment are described in conjunction with FIG. 6. Referring to FIG. 6, the number of inventory goods is calculated by counter 16 and then request handling unit 20 takes in (1) basic data (name of goods, location of vending machine, identification number ID and the like), (2) inventory alarm quantity and (3) number of inventory goods (step S20).

Comparing unit 46 compares the inventory alarm quantity with the number of inventory goods (step S21).

When the inventory number drops below the inventory alarm quantity, comparing unit 46 issues a replenish request mail producing command (step S22). Otherwise, the replenish request process is ended.

Replenish request mail producing unit 48 receives the replenish request mail producing command to prepare a replenish request mail including (1) basic data, (2) inventory alarm quantity, (3) number of inventory goods, (4) result of comparison and (5) replenish request command (step S23).

The replenish request mail is transmitted via transmitting unit 22 to a corresponding main computer 1 (step S24).

Referring again to FIG. 1, main computer 1 receives via transmitting and receiving unit 93 electronic mails from a plurality of vending machines 3A at regular and irregular intervals. Data processing unit 90 extracts sales status data and identification number included in an electronic mail for displaying the extracted data on display unit 95. Depending on a replenish request command included in the electronic mail, it is decided if the mail is a regular report mail or the one for requesting replenishment.

The extracted sales status data is stored in file 96. The data is classified and stored, for example, on the basis of identification numbers. A user of main computer 1 can know the sales status immediately and accurately based on the sales status data (including machine location, identification number ID, inventory number and the like) described in the electronic mail, the sales status including a specific commodity which is sold, a specific vending machine having sold the commodity, the location of the machine, the time of sale, and the like.

Display unit 95 indicates (1) data regarding the number of sold goods, the time of sale and the like represented by characters and numerals, or (2) location of the machine plotted on a map together with the number of sold goods, the time of sale and the like.

The sales status data received respectively by a plurality of main computers 1 are transmitted to server system 5 via network (Internet or the like) 4. Server system 5 summarizes the sales status data to update contents of database 9. The number of sold products, time of sale and the like are recorded in database 9 per vending machine (identification number).

It is noted that a plurality of registered main computers 1 may directly update database 9.

Computer 6 of a registered producer (of the goods) can refer to database 9.

As heretofore discussed, according to the first embodiment, the same electronic mail address is applied to a plurality of vending machines and a specific vending machine can be identified by a unique identification number written in an electronic mail. In this way, cost and labor of management can be saved.

Remote management of vending machines is also possible. Especially, it can be judged from an electronic mail that an out-of-stock state is approaching, and accordingly a stock can be replenished before goods are sold out.

In addition, vending machines can readily be moved since data is transmitted and received from and to the vending machines via radio, and no hard-wire work is necessary.

Further, producers can easily conduct market research by retrieving data from database 9. Then, the producers can speedily and accurately adjust inventories of products and production in factories.

Second Embodiment

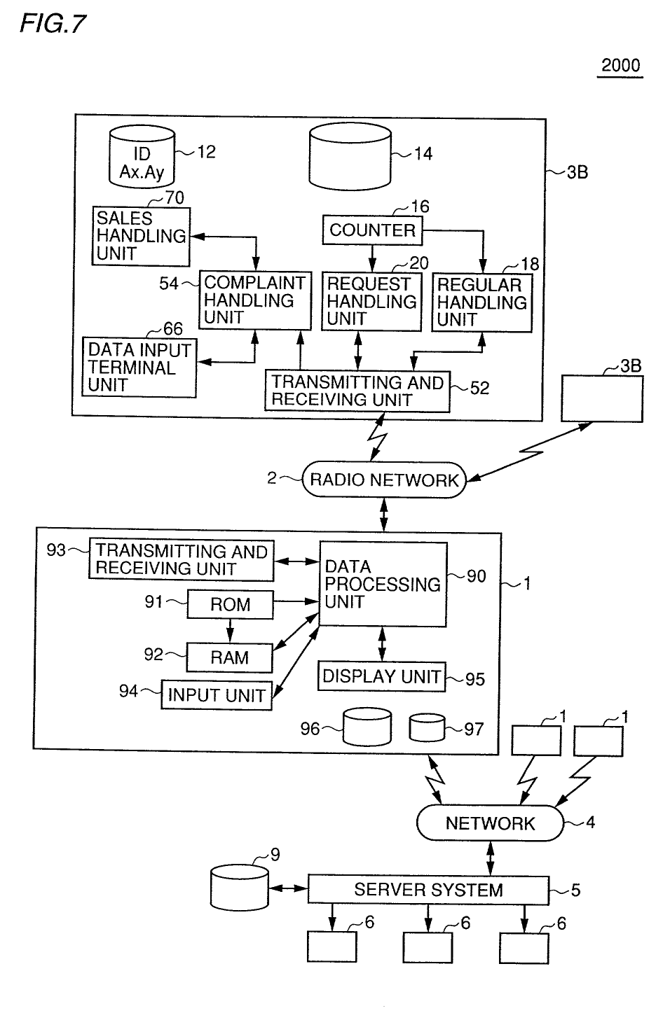

A sales management system 2000 according to a second embodiment is described below. Referring to FIG. 7, a vending machine 3B includes a sales handling unit 70, files 12 and 14, a counter 16, a regular handling unit 18 for executing a regular handling, a request handling unit 20, a transmitting and receiving unit 52 for transmitting and receiving data via a radio network 2, a complaint handling unit 54 and a data input terminal unit 66 for input of a complaint.

In a similar manner to the first embodiment, a common electronic mail address Ax is allocated to a plurality of vending machines 3B. A unique identification number ID is allocated to each of vending machines 3B. A main computer 1 manages the vending machines by using identification number ID as a key.

These vending machines 3B to which the common electronic mail address Ax is allocated are structured to transmit to a common main computer 1 electronic mails at regular and irregular intervals. The vending machines 3B to which the common electronic mail address Ax is allocated are further structured to receive electronic mails from the common main computer 1.

Complaint handling unit 54 receives consumer complaints from data input terminal unit 66 to produce a complaint handling request mail according to details of the complaints. Complaint handling unit 54 further controls sales handling unit 70 and data input terminal unit 66 in dealing with complaints.

Transmitting and receiving unit 52 sends the complaint handling request mail to electronic mail address Ay stored in file 12. Transmitting and receiving unit 52 also transmits a regular report mail and a replenish request mail to main computer 1 as transmitting unit 22 does.

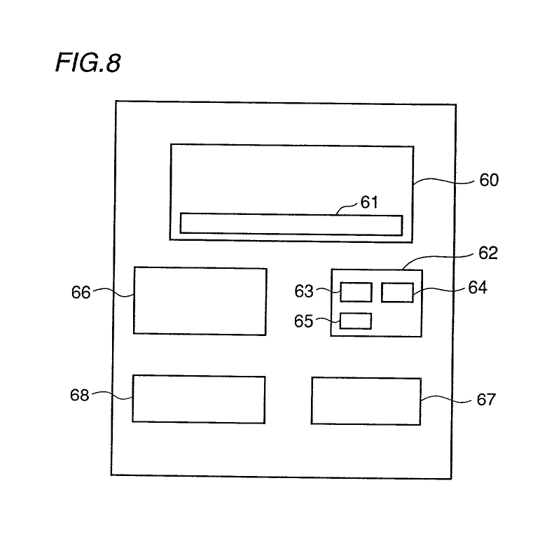

Referring to FIG. 8, the front side of vending machine 3B includes a merchandise panel 60, a payment handling unit 62, data input terminal unit 66, a dispensing outlet 67, and a return corner 68 for returning goods. Payment handling unit 62 includes a charge inlet 63, a refund button 64 and a refund opening 65.

Consumers purchase any article by putting cash into charge inlet 63 and pressing a merchandise button 61 included in merchandise panel 60. The paid charge and selected article are confirmed by sales handling unit 70. Sales handling unit 70 feeds out the article to dispensing outlet 67 if the payment satisfies the charge of the article and provides from refund opening 65 the change if any.

Data input terminal unit 66 presents a picture herein illustrated later and generates data according to a touched position on the picture. Data of data input terminal unit 66 is processed by complaint handling unit 54.

Referring again to FIG. 7, main computer 1 receives from a plurality of vending machines 3B regular report mails periodically and receives therefrom replenish request mails and complaint handling request mails at irregular intervals. Data processing unit 90 processes data of the electronic mails.

Data processing unit 90 acknowledges receipt of a complaint handling request mail and then analyzes contents thereof. According to the analyzed contents, data processing unit 90 issues a complaint handling execution command. The complaint handling execution command includes identification number ID indicated in the received complaint handling request mail.

Data processing unit 90 produces an electronic mail including the complaint handling execution command. Contents of the complaint handling request mail and details of the complaint handling execution command can be indicated on display unit 95.

The electronic mail including the complaint handling execution command is simultaneously transmitted to a plurality of vending machines 3B having electronic mail address Ax.

Complaint handling unit 54 receives the electronic mail via transmitting and receiving unit 52 to analyze the mail. Then, complaint processing unit 54 addresses any complaint in the mail.

Complaint information is stored in file 97. The complaint information is also accumulated in database 9 by classifying it on the basis of identification numbers, for example.

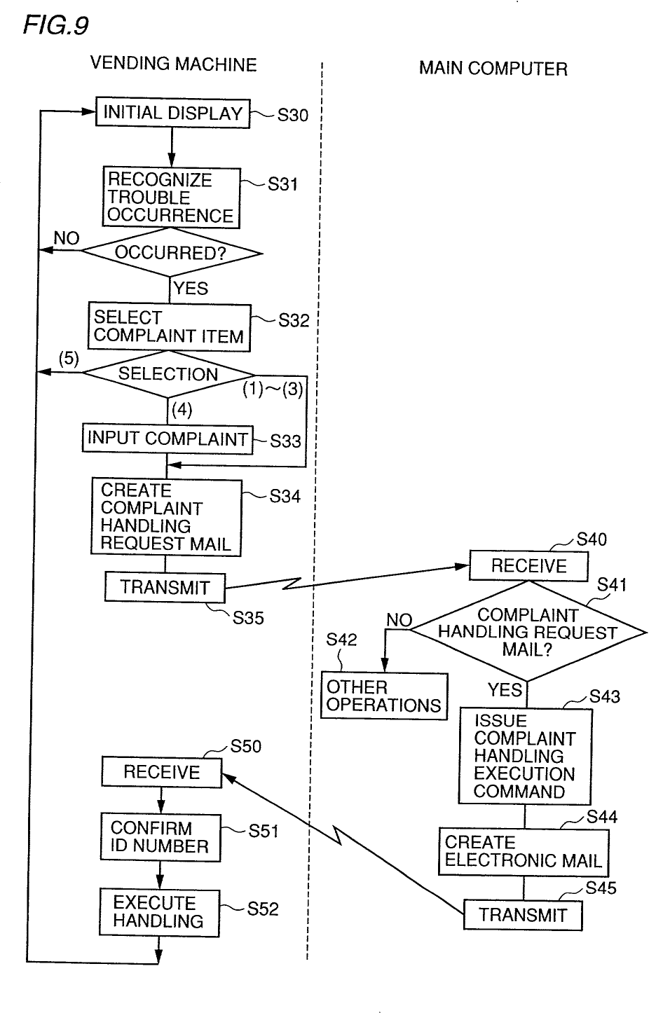

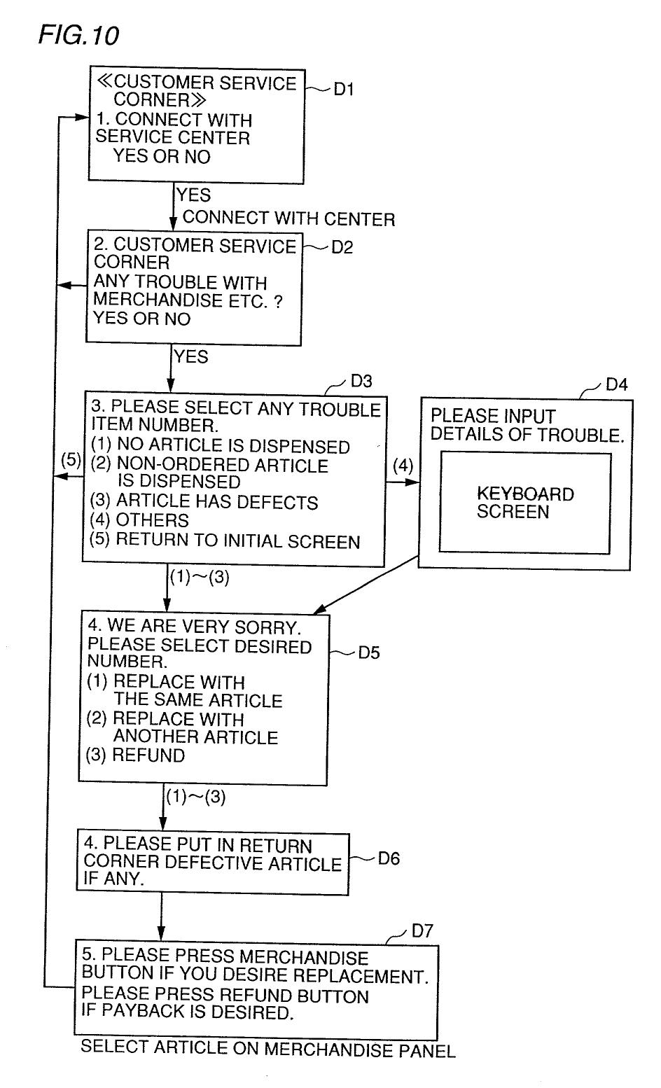

A flow of complaint handling is described in conjunction with FIGS. 9 and 10. FIG. 10 shows pictures displayed on data input terminal unit 66 by complaint handling unit 54.

An initial screen D1 shown in FIG. 10 is displayed on data input terminal unit 66 (step S30). Following the indication on screen D1, a consumer selects whether the consumer wants to be connected with a service center (“yes”) or not (“no”).

“Yes” or “no” is selected and then a screen D2 shown in FIG. 10 is displayed on data input terminal unit 66. The consumer follows screen D2 to select whether any trouble occurs (“yes”) or not (“no”) in a commodity or the like (step S31). Occurrence of a trouble is thus recognized.

If the consumer does not select occurrence of a trouble, the display returns to screen D1. If the trouble occurrence is selected, a screen D3 shown in FIG. 10 is displayed on data input terminal unit 66. According to screen D3, the consumer selects any of a plurality of displayed complaint items (step S32).

An item to be selected is, for example “(1) no article is dispensed,” “(2) non-ordered article is dispensed,” “(3) article has defects,” “(4) others” or “(5) return to initial screen.”

If “(5) return to initial screen” is selected, screen D1 is displayed. If “(4) others” is selected, a screen D4 is displayed on data input terminal unit 66. Accordingly, the consumer inputs information on any complaint by touching the keyboard screen indicated on screen D4 (step S33).

Complaint handling unit 54 receives the complaint entered from screen D4 or selected one of (1)-(3) to produce a complaint handling request mail (step S34). In the complaint handling request mail, identification number ID of the vending machine itself stored in file 12 is written.

The complaint handling request mail thus produced is transmitted via radio network 2 from transmitting and receiving unit 52 to main computer 1 (step S35).

Main computer 1 receives the electronic mail (step S40). Data processing unit 90 decides if the mail is a complaint handling request mail or not (step S41). If not, data processing unit 90 carries out operations for handling of regular report mails and replenish request mails (step S42).

If the received electronic mail is the complaint handling request mail, data processing unit 90 issues, according to contents of the request mail, a complaint handling execution command including the identification number ID indicated in the complaint handling request mail (step S43).

Data processing unit 90 then produces an electronic mail including the complaint handling execution command (step S44).

The electronic mail including the complaint handling execution command is transmitted via radio network 2 simultaneously to a plurality of vending machines 3B having electronic mail address Ax (step S45).

Transmitting and receiving unit 52 receives the electronic mail from main computer 1 (step S50). Complaint handling unit 54 receives the electronic mail including the complaint handling execution command from transmitting and receiving unit 52 to check if the identification number written in the electronic mail and identification number ID stored in file 12 match (step S51).

If they match, complaint handling unit 54 carries out actions described below (step S52).

A screen D5 shown in FIG. 10 is displayed on data input terminal unit 66. The consumer selects which action to be taken according to screen D5.

An item to be selected is “(1) replace with the same article,” “(2) replace with another article” or “(3) refund the price of article.”

Any item is selected and then a screen D6 shown in FIG. 10 is displayed on data input terminal unit 66. According to screen D6, the consumer returns a dispensed article, if any, to return corner 68.

Complaint handling unit 54 accordingly performs an action corresponding to the selected item. Specifically, a screen D7 shown in FIG. 10 is displayed on data input terminal unit 66. Following instructions on screen D7, the consumer presses merchandise button 61 included in merchandise panel 60 if the consumer requests replacement with another article, or presses refund button 64 if the consumer requests refund.

When complaint handling unit 54 judges that the consumer desires replacement with the same article, sales handling unit 70 delivers the same article as selected by the consumer to merchandise dispensing outlet 67.

When complaint handling unit 54 judges that refund button 64 is pressed, sales handling unit 70 supplies the money paid by the consumer to refund opening 65.

When complaint handling unit 54 judges that merchandise button 61 is pressed, sales handling unit 70 delivers a corresponding article to merchandise dispensing outlet 67.

The display on data input terminal unit 66 then returns to initial screen D1.

The sales management system according to the second embodiment can thus analyze by main computer 1 complaint information transmitted from vending machines and accordingly transmit from main computer 1 to a corresponding vending machine a complaint handling execution command by an electronic mail.

According to the second embodiment, in addition to the effects accomplished by the first embodiment, there is an effect that complaints can promptly be handled by an unattended vending machine.

Electronic mails can be used, not only for handling of complaints, but for updating data (inventory alarm quantity and the like) stored in file 14. In this case, main computer 1 transmits an electronic mail containing data to be updated. The electronic mail includes the identification number of a vending machine having data to be updated. File 14 receives data to be updated from main computer 1 via transmitting and receiving unit 52 and then updates that data. Main computer 1 can thus manage each vending machine from a remote location.

Although the present invention has been described and illustrated in detail, it is clearly understood that the same is by way of illustration and example only and is not to be taken by way of limitation, the spirit and scope of the present invention being limited only by the terms of the appended complaints.

What is claimed is:

1. A main computer system connected via a radio network to a plurality of vending machines each having a unique identification number, a common electronic mail address being applied to said plurality of vending machines, and
said main computer system comprising:
a transmitting and receiving unit transmitting and receiving an electronic mail via said radio network; and
a data processing unit producing a complaint handling electronic mail including a complaint handling execution command having said identification number according to a complaint handling request electronic mail including complaint information and an identification number transmitted from said vending machines.

2. The main computer system according to claim 1, further comprising a database for accumulating said transmitted complaint information by classifying the received complaint information on the basis of said identification number.

3. A client system comprising a plurality of vending machines each having a unique identification number and connected to a main computer system via a radio network,
a common electronic mail address being applied to said plurality of vending machines, and
said plurality of vending machines each including
a storing unit storing said identification number,
a mail producing unit producing an electronic mail including sales status data and said identification number, and
a transmitting unit transmitting said electronic mail to said main computer system via said radio network.

4. The client system according to claim 3, wherein
said electronic mail includes a regular report mail and a replenish request mail, and
said mail producing unit including
a counter counting the number of articles in stock at each sale of an article,
a regular handling unit regularly comparing said number of articles in stock with a stock alarm quantity to produce said regular report mail, and
a replenish request handling unit comparing said number of articles in stock with said stock alarm quantity, each time said counter operates, to produce said replenish request mail according to result of the comparison.

5. A client system comprising a plurality of vending machines each having a unique identification number and connected to a main computer system via a radio network,
a common electronic mail address being applied to said plurality of vending machines, and
said plurality of vending machines each including
a storing unit storing said identification number,
a sales management unit for selling an article,
a data input terminal unit for accepting complaint information from a consumer,
a complaint handling unit producing a complaint handling request mail including said complaint information and said identification number, and
a transmitting unit transmitting and receiving an electronic mail including said complaint handling request mail to and from said main computer system via said radio network.

6. The client system according to claim 5, wherein
said complaint handling unit invites the consumer, when an identification number included in a complaint handling electronic mail transmitted from said main computer system matches the identification number stored in said storing unit, to select one of handling items presented by said complaint handling electronic mail.

7. The client system according to claim 6, wherein
said complaint handling unit controls said sales management unit such that said consumer receives refund of money or replacement of an article according to said selected handling item.
